(19) United States
(12) Patent Application Publication
(10) Pub. No.: US 2019/0323732 A1
(43) Pub. Date: Oct. 24, 2019

(54) TRANSPARENT VACUUM TUBE CONTAINING MIRRORS AND A LIQUID TRANSFER TUBE

(71) Applicant: Hmood Mtlag Fahid ALSHAMARY, Hail (SA)

(72) Inventor: Hmood Mtlag Fahid ALSHAMARY, Hail (SA)

(21) Appl. No.: 16/310,437

(22) PCT Filed: May 16, 2017
(86) PCT No.: PCT/SA2017/000015

§ 371 Date: Dec. 16, 2018

(51) Int. Cl. F24S 20/20; F24S 23/71

(52) U.S. Cl. CPC F24S 20/20; F24S 23/71

(57) ABSTRACT

This invention is related to a transparent glass tube evacuated from air and other gases. To prevent the transferring of heat. This glass tube contains reflective mirrors that focus on the sun rays, the shape of these mirrors are (parabola). The evacuated glass tube also contains liquid carrier made of metal or glass that goes through this parabola so that the sun rays focus on it. This liquid carrier tube is coated with absorbent coatings of sun rays. Any liquid substance transferring heat, such as oil goes through this liquid carrier tube. These evacuated glass tubes can be used individually or placed in rows on a metal holder and moved according to the movement of the sun. So that the parabola mirrors are directed towards the sun then the solar rays focus on all sides of the liquid carrier tube. Then the oil will become hot and goes wherever place which it can be useful in heating the steam turbine boilers and heating swimming pools and in factories. These tubes are made in different sizes, diameters and lengths as needed, and their size is proportional to the size of the reflective mirrors and the liquid carrier tube, FIG. 1.

### BACKGROUND OF INVENTION

This invention relates to solar thermal collectors that collect sunlight to benefit from the heating of liquids. Those solar thermal collectors are three types as follow:

First: is a vacuum glass tube containing a metal plate that extends along the tube diameter and in the metal plate mediate there is a conveyor tube for liquids. It must be moved according to the sun and the liquid is not heated until the metal plate is heated, so the metal plate keeps a certain amount of heat due to the amount of the large metal. It begins to transfer the heat out by the radiation that the vacuum cannot block.

Second: A vacuum tube with inside conveyor tube for liquid, in which part of tube surface is exposed to the sun and no concentration of sunlight occurs. The diameter of the conveyor tube for fluid should be close to the diameter of the outer tube so that it has the largest area exposed to sunlight. We have a large amount of fluid that is difficult to raise to the required temperature, although this liquid is very expensive oil.

Third: Third: identical to the second type, but behind it there is a reflective mirrors focus the rays towards the vacuum tube. Its disadvantages are vulnerable to various weather conditions such as shelling small sand grains that scratch and reduce its efficiency. The dust particles, which attach to the mirrors, block the light and disperse the sun from the absorption tube. The airborne dust particles in the area between the mirrors and the absorption tube affect the solar radiation, absorb part and disperse part. The absorption tube itself is exposed to collecting dust on its surface.

Therefore, there are three stations of dust, on the mirrors, on the empty tube and in the zone of separation between them. The disadvantages of this type is the need to a large quantity of metal pieces to install the mirrors with the glass tube, so as not to be driven by the air. Any movement moves the focus rays away from the target. In addition to the cleaning difficulty because of mirrors curved shape, the slave thickness, and the cleaning difficulty of the tube because all aspects needs to be cleaned and it is difficult to clean the tubes vertical shape on the mirrors.

### GENERAL DESCRIPTION OF THE INVENTION

This invention relates to the transparent vacuum tube. This transparent glass tube consists of reflective mirrors (parabola). There is a fluid conveyor tube coated with coatings that absorb solar radiation very much in front of these reflective mirrors and focus of collecting solar radiation. The function of the fluid conveyor tube is to transfer any liquid material, such as mineral oil that absorbs heat and transfers it to where it is needed. The fluid conveyor tube is located inside the vacuum tube. The purpose of the presence of the mirrors and fluid conveyor inside the transparent vacuum tube is to protect it from dust and its effects in blocking solar radiation and damaging mirrors and fluid conveyor tube. So, by this invention, we overcome the devastating effects of dust and grains of volatile sand that scratch the mirrors. In this invention, cleaning is easy, because the need for cleaning is limited to the upper part of the tube opposite to the sun. It is easy to clean because there are no racks and vertical barriers above the tube that impede the cleaning movement as mentioned above. It also has a life span longer than the others because of there are sensitive components inside and low cost when putted on racks, so it need not many links of metal pillars in FIG. 3 and FIG. 4.

### A BRIEF EXPLANATION OF THE DRAWINGS

FIG. 1:—General front view of the invention.

FIG. 2:—Incidental cross section view of the invention. A:—Reflective Mirrors (Parabola). B:—fluids conveyer tube. C:—frame of glass tube vacuum of air and gases.

FIG. 3:—General view of the tube matrix. A—: glass vacuum tube pillar. B:—Vertical pillar.

FIG. 4:—A set of vacuum tube matrices.

### DETAILED DESCRIPTION

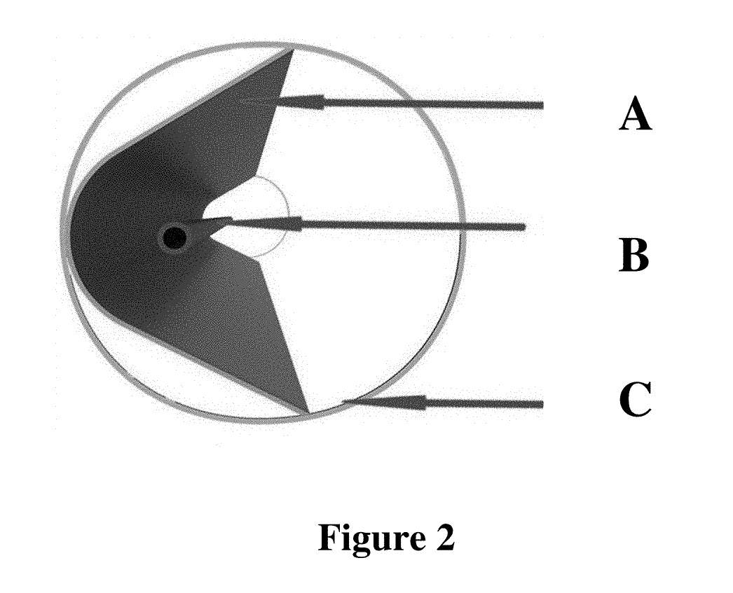

The current invention is a transparent glass tube evacuated from air FIG. (1), containing a solar focus mirrors on the parabola FIG. 2 (A). In front of these mirrors and in the focus point of the solar rays, the liquid carrier tube FIG. 2 (A) extends and coats with selective absorbent coatings for the heat of the sun. The mirrors (parabola) FIG. 2 (A) are installed at the terminal endings of the glass vacuum tube frame FIG. 2 (A) by a simple metal holder linked to mirrors. The liquid carrier tube FIG. 2 (A) is also installed at the terminal endings of the glass vacuum tube frame FIG. 2 (A) and has a non-convective material to prevent heat leakage. Many fixation methods cannot be mentioned. We can use one vacuum glass tube to work or placed in a matrix of tubes FIG. (3), where the liquid is driven for example the oil, through the liquid carrier tube FIG. (2) B. This matrix moves by the sun and reflected mirrors FIG. (2) (A) are in front of the sun, where the mirrors focus the sunrays on the liquid carrier tube FIG. (2) B.

The glass vacuum tube FIG. (1) is manufactured in different sizes and diameter sizes according to need. It is easy to clean, as it needs to be cleaned from one side that receives the sun and does not need to clean the other side as cleaning the dust suspended by the solar panels. It is one of the most important challenges facing solar energy. FIG. (3) A simple matrix of tubes, when more than one matrix is installed, we have a solar collector and it is moved to track the sun easily due to the equivalent weights on both sides FIGS. (3) and (4). This invention works efficiently in solar concentrators, which require high temperatures to evaporate water, and then rotates steam turbines that generate electricity and are used to heat ponds and plants for heat generation.

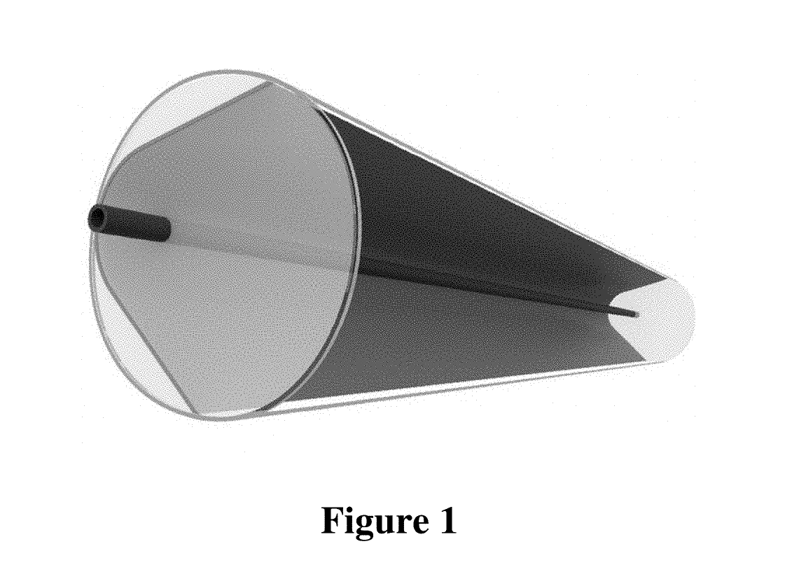

1. A transparent glass tube evacuated of air and gases (1) contains solar focus mirrors in the Fig. of parabola 2 (A). This glass tube FIG. 1 is characterized by the presence of solar focus mirrors FIG. 2 (A) inside it. There is also inside a glass tube in FIG. 1 the fluid conveyor tube FIG. 2 (B). The fluid conveyor tube FIG. 2 (B) with the extension of reflective mirrors focus (parabola) FIG. 2 (A). The fluid conveyor tube FIG. 2 (B) is made of metal or glass and it is coated with a coating that absorbs the sunrays. The area between the glass tube FIG. 2 (c) and the fluid conveyor tube FIG. 2 (b) is evacuated of air and gases to prevent heat loss.

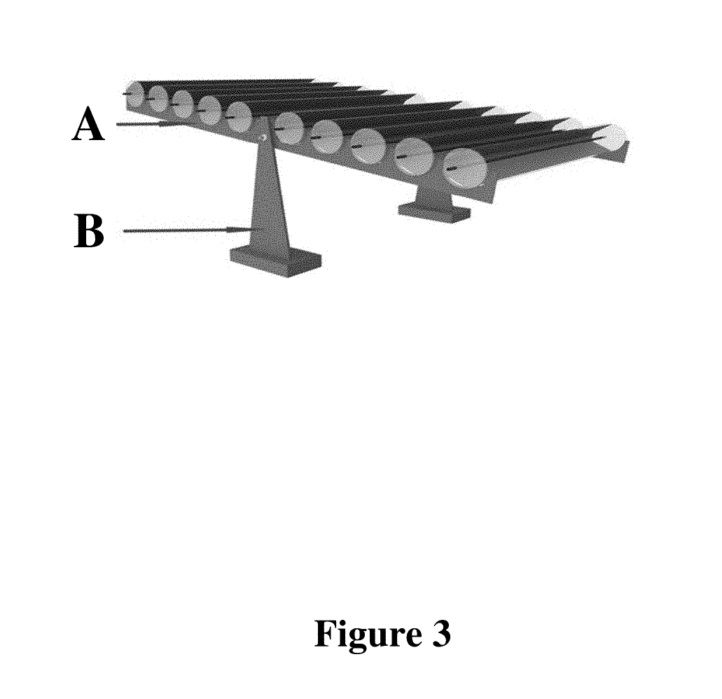

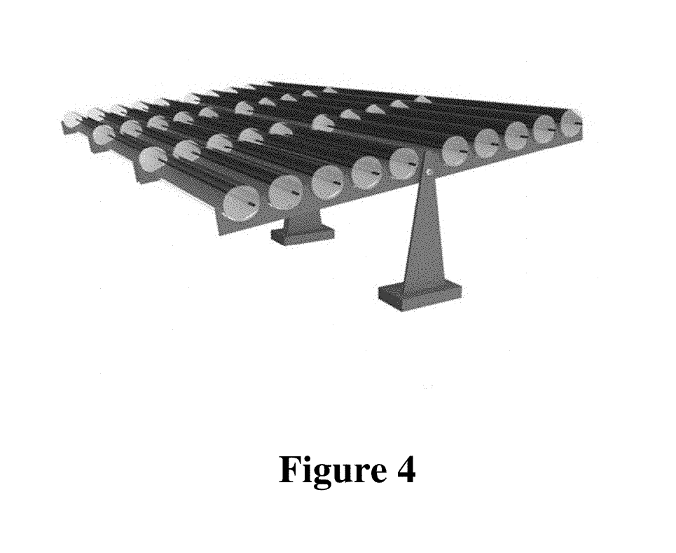

2. A solar matrix FIG. 3, consisting of a number of tubes FIG. 1, is parallel and portable on the pillars FIG. 3 (a), and there is a vertical pillar in the middle of these pillars FIG. 3 (b). The evacuated tubes FIG. 1 are of an equal number on the right and left of the vertical pillar FIG. 3 (B) and When a number of solar matrices are assembled, the solar collector is formed FIG. 4.
